(19) United States
(12) Patent Application Publication
(10) Pub. No.: US 2009/0070340 A1
(43) Pub. Date: Mar. 12, 2009

(54) METHOD FOR DISSEMINATING INFORMATION CONCERNING MEMORIAL SERVICES

(76) Inventors: John Otto, Decatur, GA (US); Christy Louise Douglas, Decatur, GA (US)

Correspondence Address: FELDMANGALE, P.A., 1700 Market Street, Suite # 3130, Philadelphia, PA, 19103, US

(21) Appl. No.: 12/185,668

(22) Filed: Aug. 4, 2008

Related U.S. Application Data
(60) Provisional application No. 60/953,884, filed on Aug. 3, 2007.

(51) Int. Cl. G06F 17/30

(52) U.S. Cl. 707/10; 707/E17.032

(57) ABSTRACT

The instant invention provides a method for disseminating information concerning memorial or other commemorative services over a system of computers accessible via the Internet.

### CROSS-REFERENCE TO RELATED APPLICATIONS

The present application claims priority benefit under 35 U.S.C. § 119(e) of U.S. Provisional Application Ser. No. 60/953,884 filed Aug. 3, 2007, the complete disclosure of which is incorporated herein by reference in its entirety.

### FIELD OF THE INVENTION

The present invention relates to the field of funeral services and in particular to the area of disseminating information concerning memorial services for a decedent or for other commemorative events.

### BACKGROUND OF THE INVENTION

Upon the death of an individual, it is traditional for families or friends to arrange for funeral or other memorial services. Indeed the funeral industry has remained a solidly profitable industry and projections for future success remain consistently high. With an aging population, the industry seems certain to continue its consistent performance.

When an individual passes away, his friends and family are often called upon to perform many traditional services at a time of great emotional stress. Typically, while funeral homes have provided services that assist those individuals, many tasks are still left to the family. Thus while the funeral home may arrange for notices to be published in local newspapers or similar publications, family and friends of the decedent are often called upon to provide information as to where and when viewings will be held, where and when interment services will be held, whether flowers or other gifts are appropriate, favorite charities of the decedent, and numerous other issues.

In addition, while funeral homes may assist with communications to the public, there may be liability issues associated with providing such information. Funeral directors must take great care to ensure that only accurate information is disseminated concerning the decedent and the family or friends' requests. Funeral homes may be exposed to liability if, for example, incorrect information concerning the schedule of memorial services or other desires and wishes of the decedent is sent by the funeral home to third parties who may rely on the incorrect information.

The use of internet based services is increasing in the funeral industry with, for example, e-wakes and similar which allow friends and families to participate electronically in various memorial services. There is as of yet, however, no existing internet solution for readily communicating information and details concerning decedents and the funeral or memorial arrangements made by the decedent's family and friends. The internet, however, provides a ready vehicle and platform for communicating detailed information concerning all aspects of the decedents' funeral or memorial services to the public and the wide circle of friends and family who may wish to participate in remembering the deceased. Accordingly, there is a need for an internet based platform that can accurately and conveniently communicate and facilitate a decedent's funeral arrangements.

From the perspective of a funeral home, internet solutions that allow the ready communication of information concerning memorial services for the decedent hold promise for facilitating and supplementing some of the services that funeral homes traditionally provide. Furthermore, such solutions may be offered as technology packages that would provide an additional revenue stream for the funeral industry, or provide a way of improving services that can distinguish one funeral home from its competitors. Indeed, the use of such internet packages may not only increase revenue for a funeral home from direct sales, but such services may also increase business volume and may further allow for the development of strategic and profitable business relationships between, for example, florists and hotels that are advertised or promoted through the internet medium in association with information concerning the decedent.

### PRESENT INVENTION

The present invention is an interactive internet website that allows for the family and friends of the decedent to publish information concerning funeral or memorial services and related information via the internet. As configured, the present invention is a web based application that generates memorial and informational webpages that can be accessed via the internet. The webpage communicates information concerning the date, time and location of funeral and internment services, the scheduling of viewings, and can convey other important and useful information concerning whether and what memorial gifts or contributions are appropriate. The webpages may also contain useful links to such ancillary services as hotels, florists, airlines or similar services that persons wishing to participate in memorials may need to access.

The present invention is marketed to funeral homes. In one embodiment, the invention may be marketed to funeral homes in predetermined bundles. Thus, funeral homes may purchase a set number, or a bundle, of webpages for use by decedents' representatives who are clients of the funeral home. As used herein, “webpage” refers to a page dedicated to a decedent that may have links to additional pages or facilities, also dedicated to the same decedent, and that may also have links to other sites and services. In alternative embodiments, the web packages may be sold directly to the public. A subdomain, for example may include the name of the funeral home. Thus the Dearborn Funeral Home who has purchased web space from a host, “At Peace,” might be identified as www.dearborn.atpeace.info. As part of the initial purchase, the webpages may be hosted for free upon a sufficient purchase of bundles or alternatively, a fee for hosting may be charged.

Initially, all funeral home purchasers will buy from the an online store site which is accessed via a commercial website accessible to client or prospective client funeral homes through a new client login. By requiring all initial purchases to be made through the OS Commerce (OS) store in one embodiment of the invention, the automated delivery of the services and the facilitation of the sign-up process for new clients may be allowed. By utilizing the online portal, new clients will be further tied to other functional aspects of the administrative database including their own administration panel wherein they may enter recurring information, initiate and automatically create new infopages using templates from within the host site's software.

The OS login is further associated with the domain site's super-administration files. By executing a purchase through the OS site, the system associates data related to the funeral home with the purchased and activated account. Once the purchase is complete, the funeral home now has acquired a bundle of webpages for sale to the funeral homes clients. By executing a purchase, the funeral home receives a number of licenses for the funeral home to transfer in connection with the services it provides to its clients.

As part of the purchase, the funeral home also receives a “tool kit” for building the webpages. The “tool kit” consists of a set of instructions and procedures that are used by the funeral director to create the customized webpages for a decedent's family or friends, and easy to use forms to assist in gathering the information needed and suggested sales techniques to use the software model to generate a new stream of income for the Funeral Home. Furthermore, upon purchase, the funeral home will be given instruction for technical support should issues arise which require additional information or expertise.

When the family representative of a decedent approaches a funeral home in connection with arranging for memorial services, the funeral director can present the family with the package and may charge that cost as part of the funeral home's bill to the decedent. If the decedent's representative purchases the service, the funeral director elicits necessary information concerning the decedent for using, editing and approving the memorial webpage. This process may be facilitated by use of forms or informational checklists that may be supplied in conjunction with a purchase by the funeral home. The funeral director then enters the necessary information into the program via the internet and an informational webpage is generated. The system then emails or contacts the decedent's representative for approval of the webpage. The approval process by the decedent's representative insulates the funeral home from liability or mitigates such liability in the event incorrect information is disseminated. Upon approval by a decedent's personal representative, the links to the webpage may be emailed or communicated via other means to an unlimited number of friends and families, and the memorial webpage will otherwise be available through a standard search on the Funeral Home's subdomain through the main host's webpage or otherwise. Online search engines may also be able to identify the Funeral Home subdomain by metatags stored in their html/php code or via other mechanisms which will be apparent to those skilled in the art.

### BRIEF DESCRIPTION OF THE DRAWINGS

FIG. 1 provides a diagram depicting the linkages and operation of one embodiment of the system according to the instant invention.

### DETAILED DESCRIPTION OF THE PREFERRED EMBODIMENT

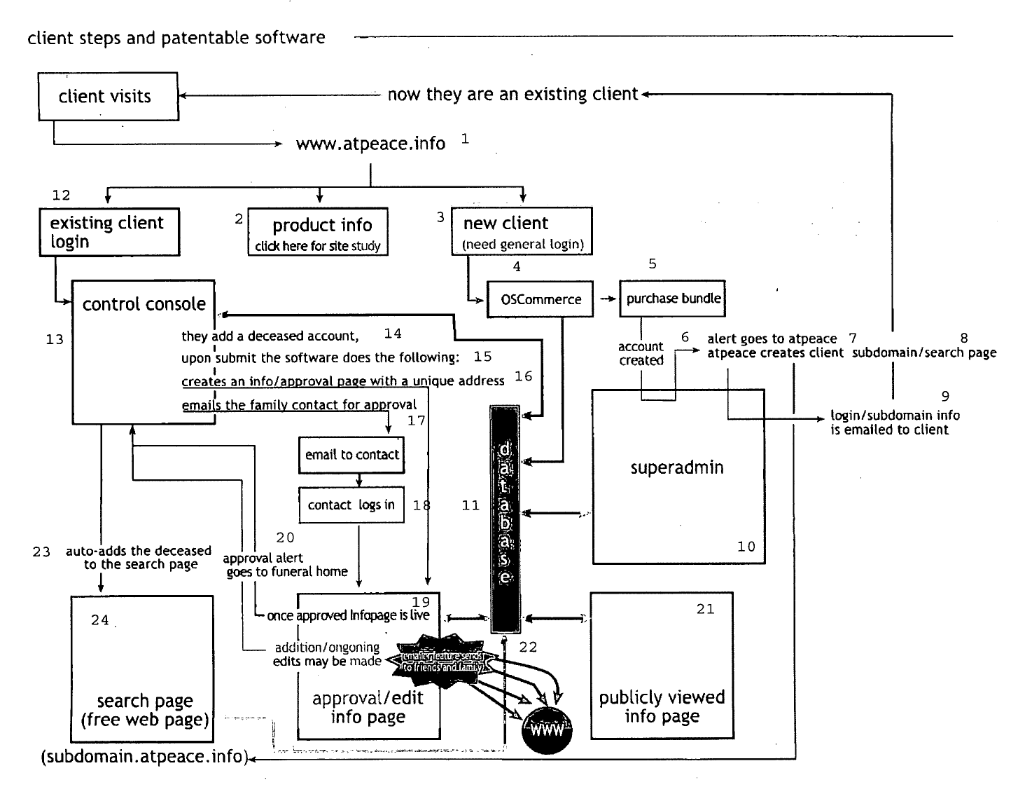

Referring now to FIG. 1, the present invention is shown in detail. The client or potential client (user) logs in through a host site web address at, for example, www.atpeace.info 1. Upon login, the client or potential client is presented various options. One link 2 provides additional product information and is used for promotional materials and for communicating general information concerning the product offering. Another link 3 provides a link for new clients. This link is followed when a funeral home wishes to purchase a bundle of webpages.

By accessing the new client link 3, the user causes the system to connect to the Online Store 4 which may be an OS Commerce open source online e-commerce site. By employing OS Commerce, the user may avoid additional expenses in constructing and maintaining the host website. Upon logging in through the new client login 3 and linking to the Online Store, the user—in this case, the client funeral home—will make an online purchase of bundles of webpages for use in connection with the funeral home's business. Upon such a purchase, a funeral home account 5 is created and maintained by the host. Upon creation of the account 5, an alert/signal is generated and the host system creates a client subdomain/search page for use by customers of the funeral home 6. The host super-administration file transmits login/subdomain information 7 to the client funeral home. Clients may also be able to select their own login usernames and passwords. The super-administration file 7a is used by the host to manage the accounts, identify industry trends and manage data related to the host's customers. From this administration tool all Funeral Home clients may be monitored at the same time.

The super-administration file is linked to a comprehensive host database 7b. The database is directly linked to numerous other nodes in the system. The OS Commerce site 4 is linked to the host database and allows creation of the client funeral home account.

Existing customers utilize a different link available at the host website. Link 8 allows existing funeral home client's to login in using the login information 7 assigned to the client. This link 8 is the primary link through which funeral homes may create a webpage for the decedent. From the existing client login 8, the funeral director is taken to a control console page 9. At the control console page 9, the funeral director or other personnel enters a decedent account 10 that has been sold or provided for the benefit of a decedent. The funeral director or other personnel will enter the information into various fields and will submit the information to the host. The control console page 9 is further linked to the host database 7b which allows for the storage of the submitted information.

Upon receiving the decedent's information, the host software will create an informational/approval page 11 exhibiting the decedent's relevant information including scheduling information and other relevant information concerning viewing times, interment times and locations and similar. The host software is set up to email 13 the webpage to a contact of the decedent's family to give that person the opportunity to ensure the accuracy of the information contained thereon. Upon receipt of the email 13, the contact will log on to the host website 14 with log on information provided by the funeral director at the time of purchase, which may be delivered via email, to review the decedent's webpage 11 and make any necessary edits or corrections. The approval process 15 includes a waiver of liability concerning the accuracy of the information contained on the webpage, and is intended to insulate and protect the funeral home from claims by the decedent's family that the information contained on the decedent's webpage 11 is erroneous. The approval 16 is communicated to the funeral director as an email, and is further sent to the host database 7b. Stored in the database, therefore, is an approved version of the memorial webpage that has been reviewed by the decedent's representative. The webpage may be later updated and edited but each time information is changed, the same approval process is repeated to ensure that all information on the publicly available version of the webpage is approved by the decedent's representative. Edited webpages overwrite preexisting versions of the webpage stored in the database, and no pre-existing versions are stored.

Once the funeral director or other authorized person receives the approval 16 of a decedent's family, the funeral director will enable 17 the webpage, and the webpage will be “auto added” 18 to a host search page that enables the public to search information concerning the decedent. The search page 19 is a publicly available page that allows the public to enter a name or other identifier of the decedent and to locate the decedent's individual webpage 20 stored on the database 7b. The webpage may be viewed by the public at no cost. The webpage may further be directly emailed by viewers to other friends and family of the decedent as a link or attachment.

In addition to containing information concerning memorial services, the webpage may also provide other information as well. The webpage may include, for example, maps and directions to pertinent locations. It may also reflect promotional materials from related businesses such as florists, hotels and airlines. These may allow for further revenue to be generated for the benefit of the funeral home as financially beneficial relationships between these enterprises may be facilitated by this use.

There are other functionalities that are exhibited by the system according to the instant invention. Once the webpage has been approved, for example, the system may send links to various email addresses identified by the decedent's representative. The emails would, for example, include a url or direct link to the decedent's webpage. The system may also be configured to allow for a text message or other form of electronic communication to be transmitted to friends and family of the decedent also directing individuals to the webpage of the decedent. Once the funeral services are completed, the host may maintain the webpage as a memorial webpage for a period of time.

I claim:

1. A method for communicating information concerning memorial services for a decedent over a network of computers accessible over the internet comprising the steps of:
a. establishing a computer domain, said computer domain being searchable;
b. establishing a sub-domain affiliated with said domain, said sub-domain being searchable;
c. creating an individual webpage for a decedent, said individual web page being associated with the sub-domain;
d. associating memorial service specific information with said individual webpage; and
e. enabling said webpage for access by computer over the internet.

2. A method for communicating information concerning memorial services over a network of computers accessible over the internet comprising the steps of:
a. establishing a computer domain, said computer domain being searchable;
b. establishing a sub-domain affiliated with said domain, said sub-domain capable being searched;
c. creating an individual decedent's draft webpage associated with the sub-domain;
d. associating specific information related to the decedent's memorial service with said individual draft webpage;
e. transmitting said draft webpage to an authorized contact for approval;
e. upon approval, enabling said webpage for access by computer over the internet.

3. The method of claim 2 wherein in said approval by the authorized contact further comprises a waiver of liability in favor of the funeral home for any erroneous information included on the decedent's webpage.

4. The method of claim 2 wherein the authorized contact may directly edit the enabled webpage.

5. The method of claim 3 further comprising the step that each time an authorized contact edits the webpage, a waiver of liability in favor of the funeral home for any erroneous information included on the decedent's webpage is executed.

6. The method of claim 2 where computer users are enabled to post additional content concerning the decedent on said enabled webpage.

7. The method of claim 2 wherein the right to create memorial service webpages are sold to purchasers in bundles comprising a set number of webpages.

8. The method of claim 6 further comprising the steps of:
a. submitting user generated content to an authorized contact for approval; and
b. enabling said user generated content upon approval by the authorized contact.

9. The method of claim 2 wherein said webpage further comprises computer links to other internet websites.

10. A method for establishing an electronic memorial for a decedent comprising the steps:
a. establishing a computer domain, said computer domain being searchable;
b. establishing a sub-domain affiliated with said domain, said sub-domain capable being searched;
c. creating an individual decedent's draft webpage associated with the sub-domain;
d. associating specific information related to the decedent with said individual draft webpage;
e. enabling said webpage for access by computer over the internet;
f. allowing individual computer users to further edit said webpage by adding additional user generated content;
g. maintaining said webpage for a period of time.
